(19) United States
(12) Patent Application Publication
(10) Pub. No.: US 2023/0373140 A1
(43) Pub. Date: Nov. 23, 2023

(54) METAL THERMOPLASTIC SANDWICH OVERMOLD

(71) Applicant: Magna Exteriors Inc., Aurora (CA)

(72) Inventors: Tushar Ashok Shegokar, Troy, MI (US); Heiner Salzmann, Metamora, MI (US)

(73) Assignee: Magna Exteriors Inc., Aurora (CA)

(21) Appl. No.: 18/320,726

(22) Filed: May 19, 2023

Related U.S. Application Data
(60) Provisional application No. 63/344,686, filed on May 23, 2022.

(51) Int. Cl. B29C 45/26; B29C 45/18; B29C 45/14; B32B 15/08

(52) U.S. Cl. CPC B29C 45/2681; B29C 45/18; B29C 45/14631; B32B 15/08; B29L 2031/30

(57) ABSTRACT

A metal and composite thermoplastic sandwich overmold adapted to achieve predetermined performance requirements without having to add metal and mass penalty to the assembly, and process to manufacture same. This is achievable by using the thermoplastic material that allows for a predetermined improved ribbing pattern that is connected to a base material. The ribbing can transfer load due to improved connection to the base material. There is provided increased plastic surface and edge encapsulation on the non-visible side of the part and the capability to provide well connected ribbing.

### CROSS-REFERENCE TO RELATED APPLICATIONS

This application is a Non-Provisional Patent Application and claims benefit of U.S. Provisional Patent Application No. 63/344,686, filed May 23, 2022. The disclosure of the above application is incorporated herein by reference.

### FIELD OF THE INVENTION

The present invention relates to a thermoplastic sandwich overmold and method for manufacturing same.

### BACKGROUND OF THE INVENTION

Overmolded side door headers have performances that do not meet desired specifications. There is significant metal reinforcement necessary to achieve specifications and requirements. Some products attempt to solve the above-described problems, including all semi structural overmolded products such as liftgate inner panels, side door inner panels, and front end carriers.

Accordingly, there is desired a system to achieve predetermined performance requirements without adding metal and weight.

### SUMMARY OF THE INVENTION

The present invention is directed to collaborative features adapted to achieve predetermined performance requirements without having to add metal and mass penalty to the assembly. According to an aspect of the present invention, this is achieved by using the thermoplastic material in a predetermined improved way. While overmolding has the capability of meeting predetermined performance, this is not to the extent that sandwich overmold can provide. Actual use of overmolding with one Class A side does not allow for sandwich molding.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side plane view of an exemplary door panel;

FIG. 2 is a cross sectional view of an overmolded door region;

FIG. 3 is a side plane view of an exemplary door panel including a sandwich region, in accordance with aspects of the present invention;

FIG. 4 is a cross sectional view of a sandwich region, in accordance with aspects of the present invention;

FIG. 5 is a side plane view of the exemplary door panel including numbered locations of displacement, load, and rotation study for overmold and sandwich result comparison;

FIG. 6 is a graph depicting study results from FIG. 5 locations with angle of twist in the X-axis; resulting from to the frame middle load case;

FIG. 7 is a rear elevation view of an exemplary liftgate including a latch region, in accordance with aspects of the present invention;

FIG. 8 is a perspective view of an overmolded latch region;

FIG. 9 is a perspective view of an exemplary sandwich latch region, in accordance with aspects of the present invention;

FIG. 10 is a perspective view of a simplified illustrative overmold model;

FIG. 11 is a cross section 11-11 of FIG. 10;

FIG. 12 is an exploded view of the simplified overmold model construction of FIG. 10;

FIG. 13 is a perspective view of a simplified illustrative sandwich model, in accordance with aspects of the present invention;

FIG. 14 is a cross section 14-14 of FIG. 13;

FIG. 15 is an exploded view of the simplified sandwich model construction of FIG. 13;

FIG. 16 is a perspective view of a sandwich assembly, in accordance with the present invention;

FIG. 17 is a cross section 17-17 of FIG. 16;

FIGS. 18A-18D are cross-sectional views of an injection molding tool; and

FIGS. 19A-19D are cross-sectional views of an exemplary method of manufacturing an encapsulated part, in accordance with aspects of the present invention.

### DETAILED DESCRIPTION OF THE PREFERRED EMBODIMENTS

The following description of the preferred embodiment(s) is merely exemplary in nature and is in no way intended to limit the invention, its application, or uses.

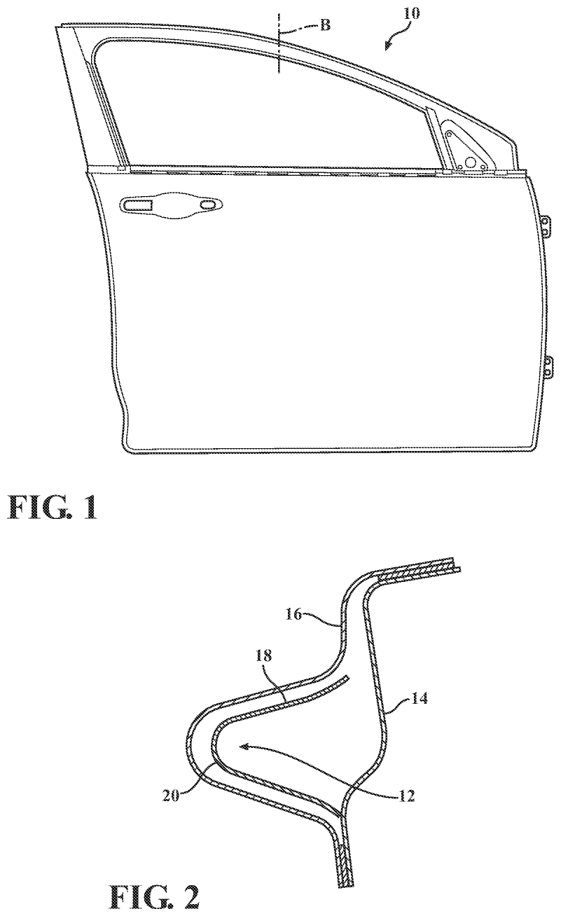

Referring to FIGS. 1-19D generally, the present invention provides a thermoplastic sandwich overmold assembly adapted for a vehicle, preferably, a metal/composite and thermoplastic sandwich overmold, and method of making same. The present invention allows several advantages including as follows: Helps better load transfer metal to plastic in critical areas; Allows for improved ribbing pattern that is well connected to the base material (not only through edge molding and small through molding holes); Ribbing is capable of load transfer due to better connection to base material and make the whole metal work; and Increased plastic surface and edge encapsulation on the non-visible side and the capability to provide well connected ribbing. In accordance with aspects of the present invention, a special tooling concept provides the capability of having grained Class A surface on one side of the sandwich and still have sufficient plastic on the ribbing side to provide increased performance.

FIG. 1 depicts an exemplary door adapted for a vehicle shown generally at 10. FIG. 2 depicts a cross section taken at CB′ of FIG. 1 if the part were overmolded, indicated generally at 12. There is depicted an outer panel 14 connected to an inner panel 16, a metal portion 18 (e.g., reinforcement, bracket, latch, etc.), and an overmolded button portion indicated at 20.

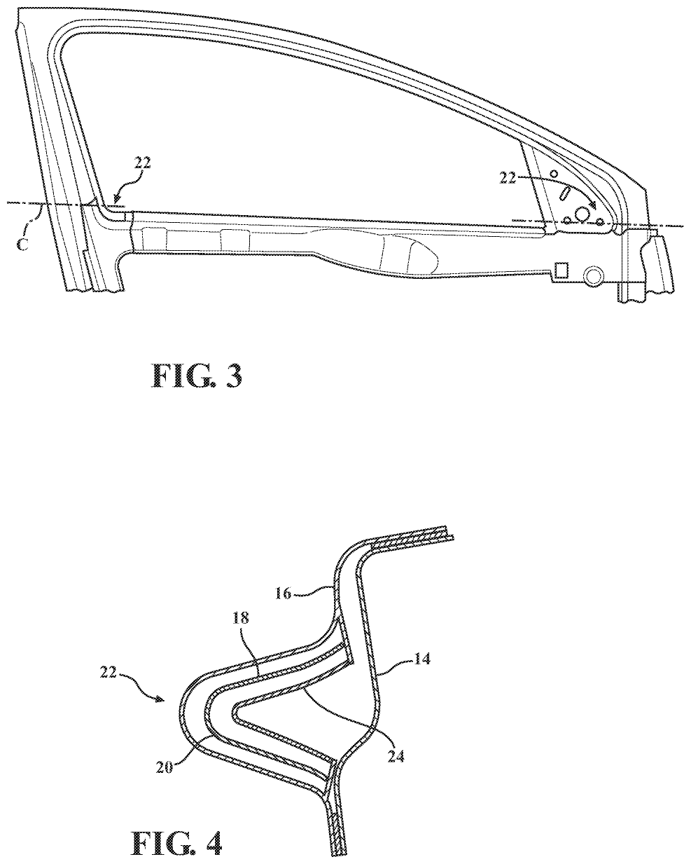

According to aspects of the present invention, and referring more particularly to FIGS. 3-4, there is depicted exemplary sandwich modeling wherein there is added at least one first (e.g., inner) panel material (to sandwich) indicated at 24, according to aspects of the present invention. FIG. 3 indicates metal and/or composite sandwiched between the opposite exemplary regions 22,22 of the door at section indicated at line CB′. FIG. 4 depicts at least one second (e.g., outer) panel 14 operably connected to at least one first (e.g., inner) panel 16 (e.g., adhesive, infrared welded, sonic welded, etc.), at least one reinforcement (e.g., metal/composite) portion 18 (e.g., metal, bracket, latch, flange, ridge, rib, web, etc.), at least one overmolded button portion indicated at 20, and the additional inner panel material 24 arranged such that the metal/composite 18 is operably sandwiched between the inner panel 18 and additional inner panel material 24. Alternatively, the sandwich material can be an outer panel 14 material and additional segment depending on the application without departure from the scope of the present invention.

It is understood that the sandwich overmolding is not necessarily restricted to this section of the window frame indicated at line ‘C’ or a frame. It is understood the sandwich is operably adaptable to be used in any predetermined location(s), including operably adapted to be used where operably operational in every area of the overmolded door structure (or liftgate structure or other predetermined structure). The sandwich modeling applied to a frame with limited cross section, as depicted, by way of example, also allows a way to stay within that limited cross section.

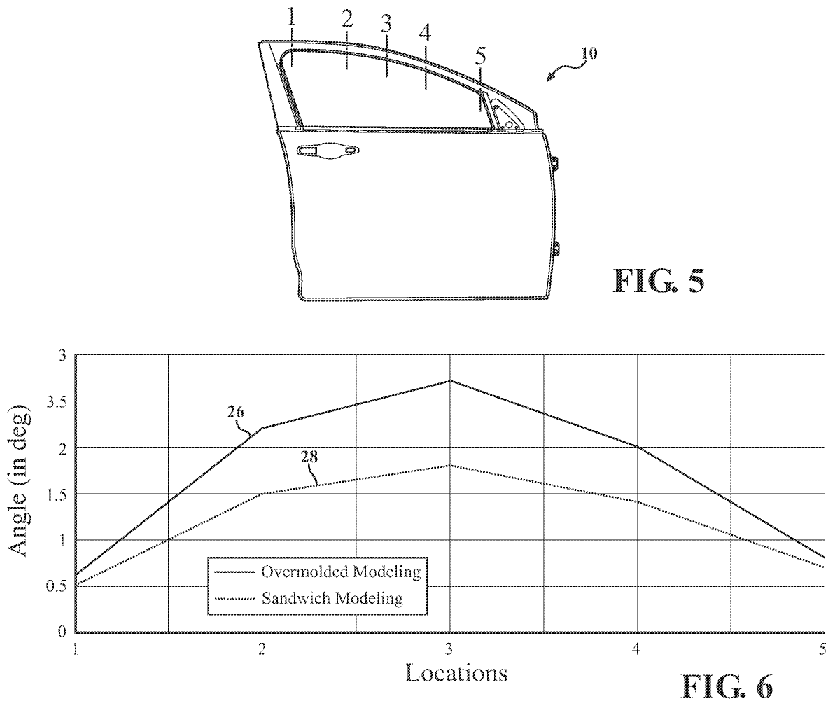

Referring now more particularly to FIGS. 5-6, there is illustrated exemplary testing results of the door at predetermined locations (locations numbered “1” through “5” indicated in FIG. 5) and results depicted in graph 6 between overmolding modeling versus sandwich modeling in accordance with aspects of the present invention. The exemplary test is generally a door frame middle load case and is generally a twist comparison The overmolding line for test results of a study subject is indicated at 26. The sandwich line test results of a study subject incorporating a sandwich material arrangement (e.g., FIG. 4) is indicated at 28. The x-axis sets forth the numbers 1-5 corresponding to locations 1-5 labeled in FIG. 5. The y-axis sets for the angle (in degrees) such that a twist.

Graph of FIG. 6 shows that the max twist in the overmolded modeling is at least about 2.8 degrees, and that the max twist in sandwich modeling is about 1.9 degrees.

In addition, Table 1 is set forth below detailing peak displacements, load point displacements, and rotation results for the overmolding modeling and sandwich modeling.

TABLE 1

| | | | Overmolding | Sandwich | |
|---|---|---|---|---|---|
| | | | modeling | modeling | |
| Load case | Analysis type | | results | results | % improvement |
| Frame Middle | Static | Peak displacement | 6.6 | 5.4 | 18% |
| | | (in mm) | | | |
| | | Load point | 5.5 | 4.8 | 13% |
| | | displacement | | | |
| | | (in mm) | | | |
| | | Rotation | 2.8 | 1.9 | 32% |
| | | (in deg) | | | |

The results make evident that sandwich modeling was at least about 32% better than the overmolded modeling in twist. This helps to improve the peak displacement by at least about 18% and load point displacement by at least about 13%. This is very significant to help meet load case without much addition of mass (by weight or size). Additionally, having plastic on the inside now opens up the options of honeycomb structuring (or other suitable shapes) which again is more stiffness without much mass penalty.

In accordance with aspects of the present invention, sandwiching in accordance with aspects of the present invention is generally at least about 15 to 50 percent better than overmolded undesirable twisting, typically about 20 to 40 percent better, preferably about 25 to 35 percent better, and more preferably at least about 32% better than the overmolded modeling in twist.

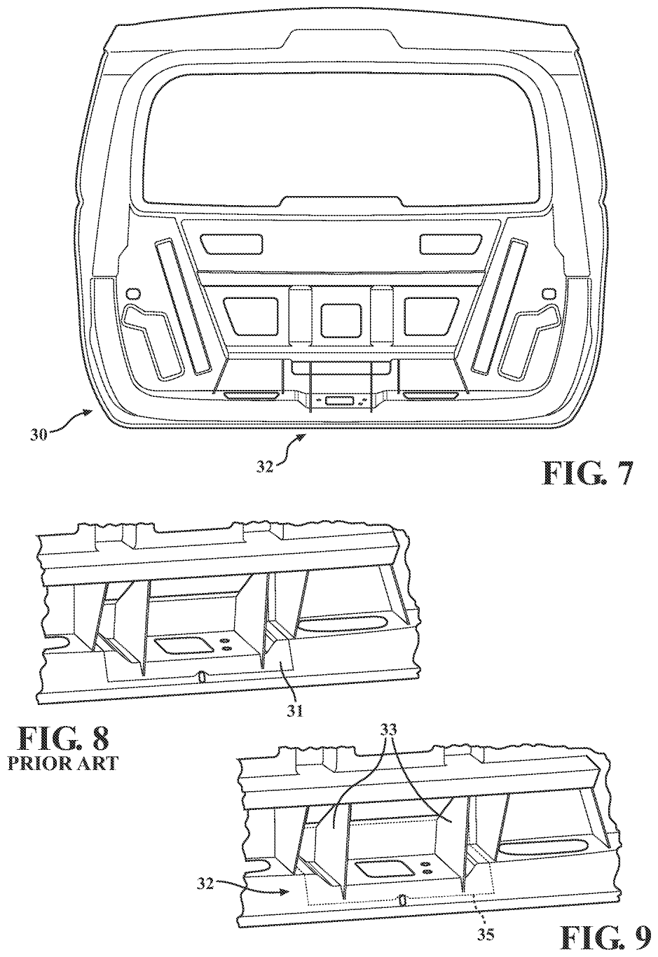

Referring now more particularly to FIGS. 7-9 there is depicted a semi-structural product (e.g., tailgate, FIG. 7) in accordance with the present invention (e.g., FIG. 9), that depicts an exemplary liftgate shown generally at 30 incorporating a latch pullout area shown generally at 32, wherein FIG. 8 depicts an exemplary conventional overmold modeling latch pullout 31, and FIG. 9 depicts an exemplary sandwich modeling according to aspects of the present invention. FIG. 9 also includes exemplary ribbing 33 capable of load transfer due to better connection to base material 35 and make the whole metal work; and increased plastic surface and edge encapsulation on the non-visible side and the capability to provide well connected ribbing 33.

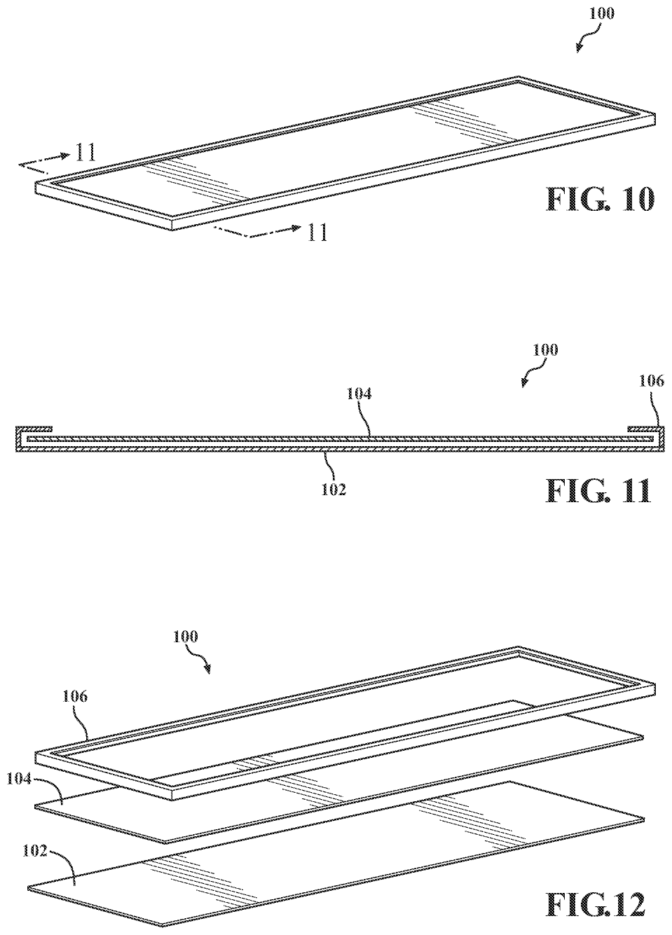

Referring now to FIGS. 10-12, there is depicted a simple construction overmold model. The overmold model is indicated generally at 100 and has an inner panel 102, metal 104 (e.g., insert, reinforcement, etc.), and overmold 106. FIG. 10 is a perspective view of a simplified illustrative overmold model. FIG. 11 is a cross section taken at 11-11 of FIG. 10. FIG. 12 is an exploded view of the simplified overmold model construction.

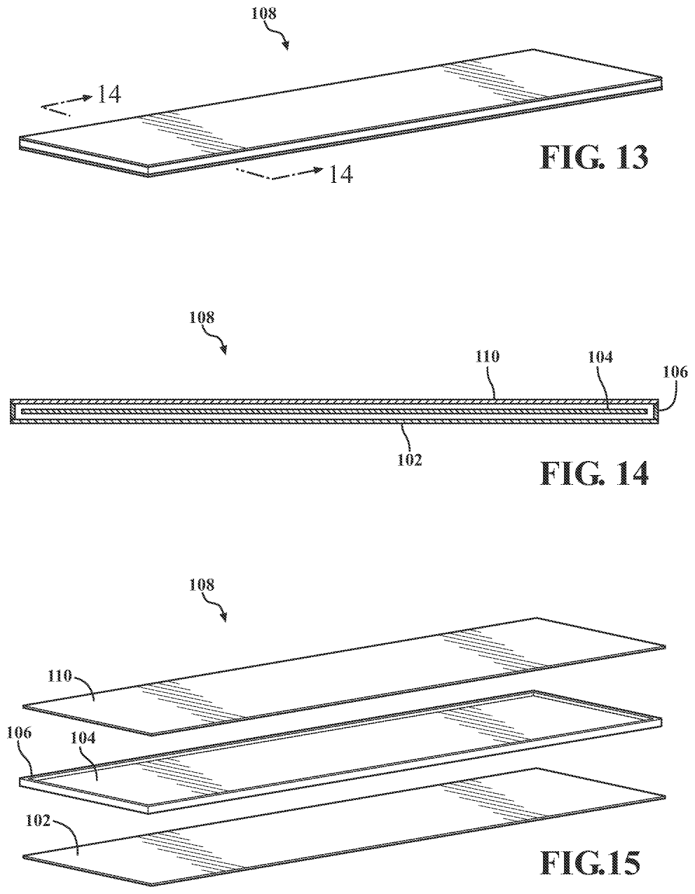

Referring more particularly to FIGS. 13-15, there is depicted an illustrative simple construction sandwich model, in accordance with aspects of the present invention. The sandwich model is indicated generally at 108 and has an inner panel 102, reinforcement 104 (e.g., steel, insert, metal, and/or composite, or other suitable material, etc.), overmold 106, and the inner panel 102 includes at least one additional inner panel 110 to substantially sandwich the reinforcement 104 in the inner panel 102,110. FIG. 13 is a perspective view of the simplified illustrative sandwich model. FIG. 14 is a cross section 14-14 of FIG. 13. FIG. 15 is an exploded view of the sandwich model of FIG. 13. There is at least partial edge overmold of the reinforcement 104.

Table 2 is set forth below detailing load test types and results for the overmolding modeling and sandwich modeling (e.g., of FIGS. 10 and 13).

TABLE 2

| | | Max displacement (in mm) | | |
|---|---|---|---|---|
| | | Overmolding | Sandwich | |
| Load case | Description | modeling | modeling | % improvement |
| Bending Load | OM: all ends encapsulated | 4.6 | 5.3 | −15% |
| | Sandwich: 1.5 mm plastic on | | | |
| | both end | | | |
| | OM encapsulated only on | 6 | 5.3 | 12% |
| | 50 mm edge | | | |
| | Sandwich: 1.5 mm plastic | | | |
| | on both end | | | |
| | OM encapsulated only on | 6 | 4.6 | 23% |
| | 50 mm edge | | | |
| | Sandwich is 2 mm and 1.5 mm | | | |
| | plastic | | | |
| Angular Load | OM all ends encapsulated | 6.2 | 6.5 | −5% |
| | Sandwich: 1.5 mm plastic on | | | |
| | both end | | | |
| | OM encapsulated only on | 6.9 | 6.5 | 6% |
| | 50 mm edge | | | |
| | Sandwich: 1.5 mm plastic on | | | |
| | both end | | | |
| | OM encapsulated only on | 6.9 | 5.5 | 20% |
| | 50 mm edge | | | |
| | Sandwich is 2 mm and 1.5 mm | | | |
| | plastic | | | |
| Cantilever Load | OM all ends encapsulated | 131.4 | 120.3 | 8% |
| | Sandwich: 1.5 mm plastic on | | | |
| | both end | | | |
| Pull Load | OM all ends encapsulated | 1.11 | 0.14 | 87% |
| | Sandwich: 1.5 mm plastic on | | | |
| | both end | | | |
| Frame Middle | OM all ends encapsulated | 5.5 | 4.8 | 13% |
| | Sandwich is 3 mm on both end | | | |
| Bending Load | OM all ends encapsulated | 14.4 | 11.5 | 20% |
| | Sandwich is 3 mm on both end | | | |
| Angular Load | OM all ends encapsulated | 29.2 | 19.7 | 33% |
| | Sandwich is 3 mm on both end | | | |
| Cantilever Load | OM all ends encapsulated | 62 | 24.4 | 61% |
| | Sandwich is 3 mm on both end | | | |
| Pull Load | OM all ends encapsulated | 0.35 | 0.15 | 57% |
| | Sandwich is 3 mm on both end | | | |

| | | Force at first Failure (in N) | | |
|---|---|---|---|---|
| | | Overmolding | Sandwich | |
| | Description | modeling | modeling | % improvement |
| Latch Pull | OM all ends encapsulated | 12326 | 18612 | −51% |
| | Sandwich is 3 mm on both end | | | |

The results make it evident that sandwich modeling is very significant to help to meet load case without much addition of weight. In addition, having plastic on inside now opens up the options of honeycomb structuring which again is more stiffness without much mass penalty. Overmolding modeling has the stress concentration on the encapsulations and overmolded buttons, versus sandwich modeling having the stress concentration distributed. By way of non-limiting example, with adding about 3 mm plastic on both sides, performance can be improved by at least about 20 to 90%, typically, by at least about 40 to 75%, preferably, by at least about 50 to 70%, more preferably, by about 45 to 60%, most preferably, by at least about 60%—with more opportunity to optimize even further. Dynamic load cases like latch pull is also improved with sandwich modeling. by at least about 20 to 90%, typically, by at least about 30 to 75%, preferably, by at least about 35 to 65%, more preferably, by about 45 to 60%, most preferably, by at least about 50%

Generally, there is about 1 to 7 mm of plastic, e.g., on both sides, typically, about 1 to 5 mm of plastic on both sides, preferably, about 2 to 4 mm of plastic on both sides, more preferably, about 2.5 to 3.5 mm of plastic on both sides, and most preferably about 3 mm of plastic on both sides. The about of plastic on both sides can be the same amount or different amount (e.g., thickness), preferably the same amount. It is understood that the amount of plastic is operably adaptable depending on the particular application without departure from the scope of the present invention.

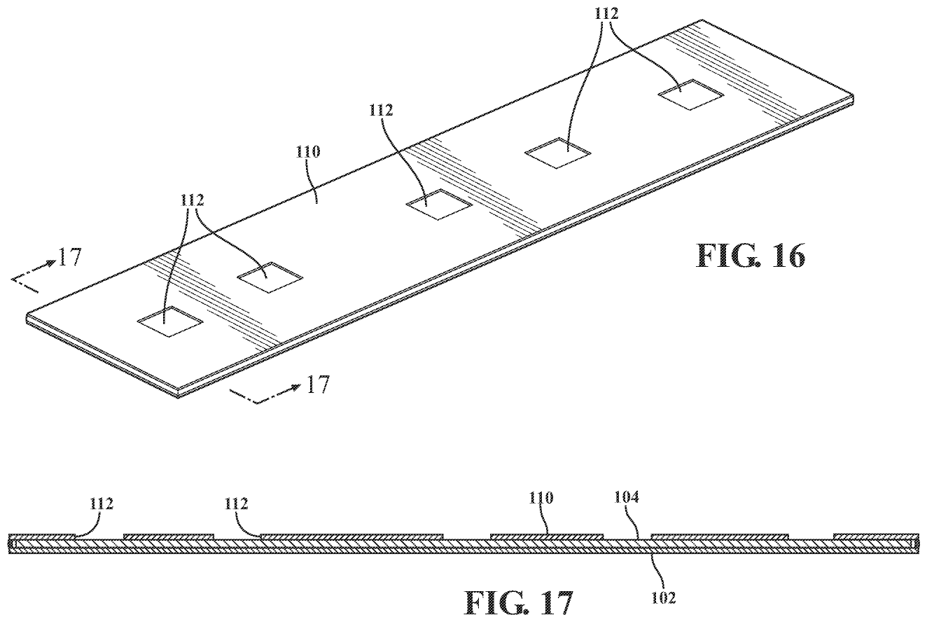

Referring now more particularly to FIGS. 16-17, there is provided at least one, preferably, a plurality of locator openings 112 at predetermined location(s) in at least one layer of plastic (e.g., first panel 110) suitable and adapted for the manufacture of the present invention, in accordance with aspects of the present invention. The sandwiching is preferably manufacturable when there are locator openings in one layer of the plastic. FIGS. 15 and 17 show encapsulation of the metal (and/or composite) sheet 104. The locator openings 112 of FIGS. 16-17 are schematic. Suitable shape(s), size(s), location(s), dimensions, surface(s), number(s)/amounts, can vary depending on the particular applications. It is understood that the exact design of the suitable openings is determinable by CAE work (structural and material flow analysis) depending on the particular application without departure from the scope of the present invention.

The locator openings 112 are one preferred way to provide manufacturability of the present invention, e.g., insert tooling. It is understood that alternative suitable features adaptable for manufacturing are contemplated without departure from the scope of the present invention.

Locator openings 112 is one way to manufacture the metal thermoplastic sandwich assembly. By way of example, at least one molding tool is provided and by suitable design of the predetermined locator openings 112 and the design of the sandwich part, the predetermined molding material will flow in a way that the metal will always be pressed by the molding material pressure in the molding tool on the predetermined correct side of the molding tool. This has not been done before to the extent that the focus is on encapsulating the metal as much as possible.

There are other ways to achieve the encapsulation, e.g., incorporating using an insert tool, insert molding, or using a two shot process with two tools with same functions, etc. For example, providing an injection molding tool having an injection molding tool that encapsulates only one side and the edges of the predetermined metal. Then the one tool half, that sits flush on the metal surface, moves away/rotates and is replaced by a tool half with a cavity that provides the space for the plastic to encapsulate the other half of the metal.

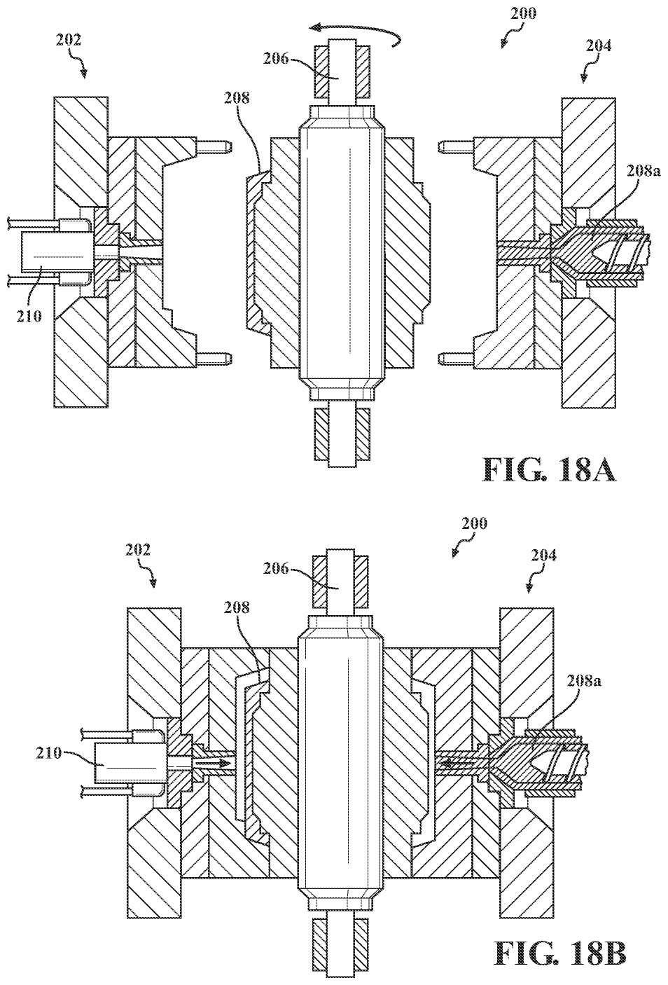

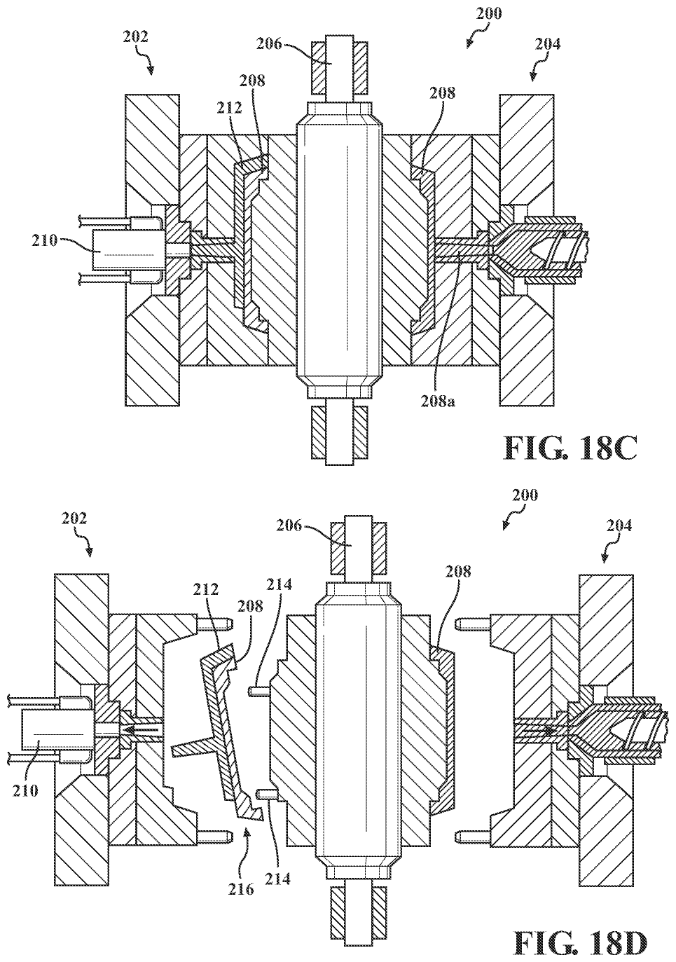

Referring more particularly to FIGS. 18A-18D, there is depicted a molding tool, indicated generally at 200, including a first and second half, indicated generally at 202 and 204, at least one mixing head 210, and an insert portion 206 that selectively turns or rotates. A predetermined injection molded carrier 208 is provided, e.g., prior to rotating the insert portion 206. The tool 200 is closed, indicated as arrows at 202 and 204 in FIG. 18B. A predetermined material is selectively delivered 208a, forming an injection molded carrier 208, indicated in FIG. 18C. In addition, the mixing head 210 selectively provides a layer of predetermined material 212 against the injection molded carrier 208 (see FIG. 18C). The first and second halves 202 and 204 are opened and a pair of ejectors 214 push off the finished component indicated generally at 216.

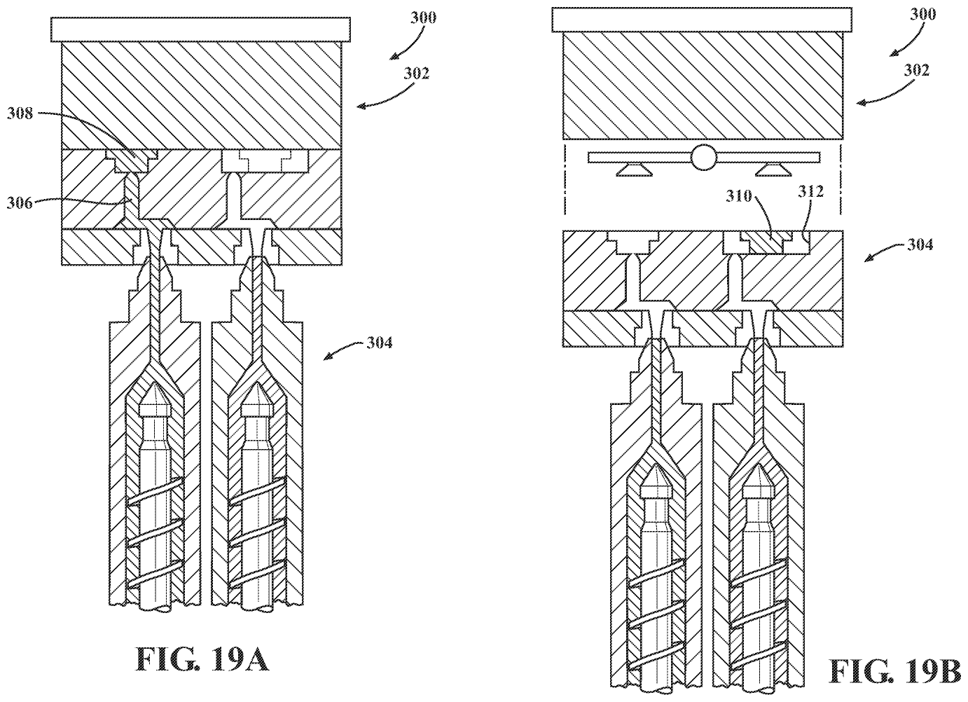

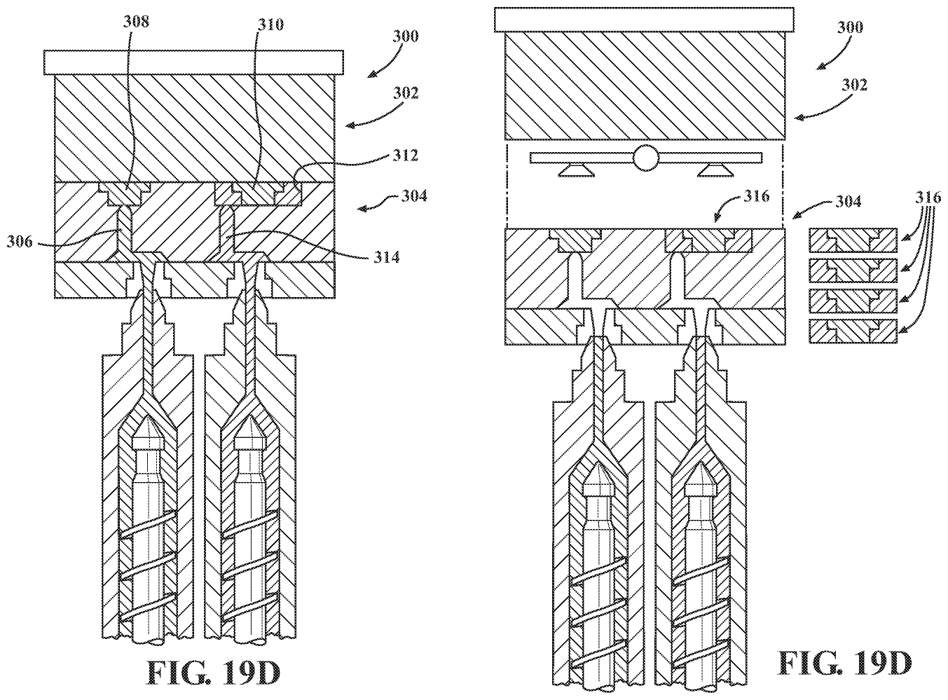

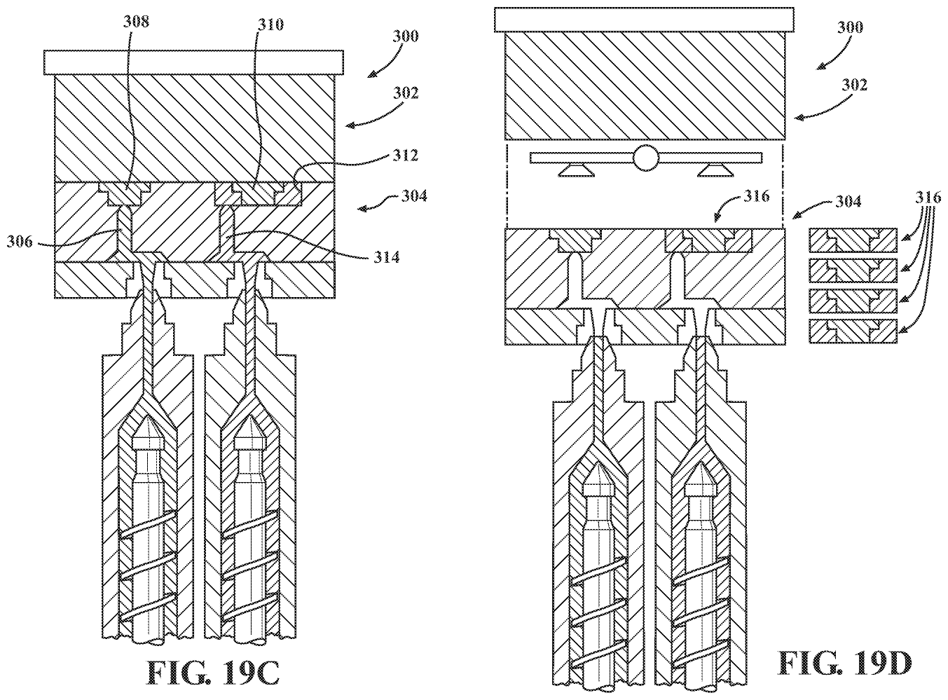

Another method of manufacture is a two-shot process with two tools with the same functions. Referring more particularly to FIGS. 19A-19D, there is depicted exemplary tooling and method of manufacturing an encapsulated part. There is provided 2-shot injection molding tooling, indicated generally at 300, and at least the following steps. At Step 1, a first tooling half 302 of the press is closed against a second tooling half 304, and a first shot of predetermined material 306 is injected into a first mold 308 (see FIG. 19A). At Step 2, the press is opened, and the first part 310 created from the first shot of material 306 is robotically transferred to a second mold 312. At Step 3, the first tooling half 302 of the press closed against the second tooling half 304, and a first shot of the predetermined material is injected into the first mold 306, and a second shot of predetermined material 314 is injected into the second mold 312 around the first part 310 creating a 2-shot part, indicated generally at 316. At Step 4, the press is opened, and the completed 2-shot part 316 is robotically removed. The cycle then starts again.

Referring to FIGS. 1-19D generally, the present invention allows several advantages including: assisting with load transfer reinforcement (e.g., metal) to plastic in critical areas; Allows for improved ribbing pattern that is well connected to the base material (not only through edge molding and small through molding holes through at least the additional inner panel); Ribbing is capable of load transfer due to better connection to base material and make the whole metal work; and Increased plastic surface and edge encapsulation on the non-visible side and the capability to provide well connected ribbing. In accordance with aspects of the present invention, a special tooling concept provides the capability of having grained Class A surface on one side of the sandwich and still have sufficient plastic on the ribbing side to provide increased performance.

Referring to FIGS. 1-19D generally, while a door and a liftgate are depicted in accordance with the present invention, it is understood that the present invention is operably adaptable for any vehicle body panel, inner panel, outer panel, liftgate panel, door panel, roof, hood, tailgate, bumper, rocker panel, instrument panel, front end carrier, front door, rear door, bed or pickup tailgate, and any other predetermined part depending on the application without departure from the scope of the present invention.

While metal material is described (e.g., steel, etc.) it is understood that any suitable materials are contemplated depending on the application without departure from the scope of the present invention (e.g., steel, aluminum, composites, fiber reinforced material, glass reinforced, any other suitable material, etc., and combinations thereof.

While thermoplastic is described, it is understood that any materials suitable for sandwich and meeting predetermined properties and requirements are contemplated depending on the application without departure from the scope of the present invention. E.g., PP, composite, glass, or fiber reinforced material, etc.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A thermoplastic sandwich overmold assembly adapted for a vehicle, comprising:
at least one first panel portion;
at least one second panel;
at least one reinforcement; and
at least one additional first panel portion, wherein said reinforcement is sandwiched between the first panel portion and additional first panel portion.

2. The thermoplastic sandwich overmold assembly of claim 1, wherein the reinforcement is metal.

3. The thermoplastic sandwich overmold assembly of claim 1, wherein said reinforcement includes an overmold.

4. The thermoplastic sandwich overmold assembly of claim 3, wherein the overmold is at least edge encapsulation on a non-visible side.

5. The thermoplastic sandwich overmold assembly of claim 3, further comprising ribbing, wherein the overmold provides well connected ribbing to predetermined base material of one of said panels and/or reinforcement.

6. The thermoplastic sandwich overmold assembly of claim 1, wherein said at least one first panel includes a plurality of locator openings.

7. The thermoplastic sandwich overmold assembly of claim 1, further including a predetermined ribbing pattern operable to transfer load.

8. The thermoplastic sandwich overmold assembly of claim 7, wherein the ribbing is incorporated with or operably connected to at least the reinforcement.

9. The thermoplastic sandwich overmold assembly of claim 7, wherein said thermoplastic sandwich overmold includes grained Class A surface on one side of the sandwich and predetermined amount of plastic sufficient on a ribbing side to provide predetermined performance.

10. The thermoplastic sandwich overmold assembly of claim 1, including plastic surface and edge encapsulation on a non-visible side, and optionally, well connected ribbing.

11. The thermoplastic sandwich overmold assembly of claim 1, wherein said thermoplastic sandwich overmold assembly is operably adapted for a door assembly of a vehicle or vehicle liftgate.

12. The thermoplastic sandwich overmold assembly of claim 1, wherein said
said at least one first panel portion is an inner panel;
said at least one second panel is an outer panel;
said at least one reinforcement is a metal including an overmolded button portion; and
said at least one additional first panel portion is an added inner panel.

13. The thermoplastic sandwich overmold assembly of claim 1, further including a plurality of locator openings formed through at least one layer of plastic material operably adapted for allowing predetermined material to encapsulate at least the reinforcement.

14. The thermoplastic sandwich overmold assembly of claim 1, further including a plurality of locator openings, wherein at least one predetermined molding material will flow in a way that the reinforcement of metal will always be pressed by a molding material pressure in a molding tool on a predetermined correct side of the molding tool for at least partially encapsulating the metal.

15. A thermoplastic sandwich overmold assembly adapted for a vehicle, comprising:
at least one first layer of thermoplastic;
a plurality of openings through said at least one first layer;
at least one metal and/or composite layer;
at least one additional layer of thermoplastic, wherein said at least one metal and/or composite layer is sandwiched between the first layer of thermoplastic and additional layer.

16. The thermoplastic sandwich overmold assembly of claim 15, wherein said at least one metal and/or composite layer is encapsulated by the first layer of thermoplastic and additional layer.

17. The thermoplastic sandwich overmold assembly of claim 15, wherein the metal and/or composite layer is at least edge encapsulated on a non-visible side.

18. The thermoplastic sandwich overmold assembly of claim 15, wherein the metal and/or composite layer is steel.

19. A method of manufacturing a metal thermoplastic sandwich overmold assembly adapted for a vehicle, comprising:
providing at least a first predetermined molding material;
providing at least one reinforcement;
providing molding tooling adapted and by suitable design of predetermined locator openings and the design of the sandwich assembly, the predetermined molding material will operably flow within the molding tooling in a way that the at least one reinforcement will always be pressed by molding material pressure in the molding tool on the predetermined correct side of the molding tool; and wherein the molding material encapsulates the reinforcement.

20. The method of claim 19, at least one additional first panel portion, wherein said reinforcement is metal.
